(19) United States
(12) Patent Application Publication
(10) Pub. No.: US 2008/0196253 A1
(43) Pub. Date: Aug. 21, 2008

(54) Precision knife and blade dispenser for the same

(76) Inventors: Richard Simon Ezra, Randolph, NJ (US); Ronald Aniceto, Hawthorne, NY (US)

Correspondence Address: SOFER & HAROUN LLP., 317 MADISON AVENUE, SUITE 910, NEW YORK, NY, 10017, US

(21) Appl. No.: 11/903,748

(22) Filed: Sep. 24, 2007

Related U.S. Application Data
(63) Continuation-in-part of application No. 11/511,180, filed on Aug. 28, 2006.

(51) Int. Cl. B26B 5/00

(52) U.S. Cl. 30/124; 30/329

(57) ABSTRACT

A combination precision knife and blade dispenser having a handle portion configured to receive a blade and a dispenser. The dispenser is configured to support at least one blade in a new blade portion thereof. The dispenser further has a used blade portion configured to support at least one blade therein, where a user, manipulates the handle portion and engages a base of the at least one blade therein, and where in order to dispose of the blade, the user inserts the blade into the dispenser and disengages the base of the blade from the handle portion such that at no time does a user need to touch an edge portion of the blade.

### RELATED APPLICATION

The present invention is a continuation-in-part of U.S. patent application Ser. No. 11/511,180, filed on Aug. 28, 2006, the entirety of which is incorporated by reference.

### FIELD OF THE INVENTION

The present invention is directed to the field of knives. More particularly, the present invention is directed to the field of craft or precision knives.

### BACKGROUND OF THE INVENTION

In the craft and related industries, precision knives are used for a number of different tasks. These precision knives are typically used for detailed cuts, such as cutting along borders, removing and cleaning model parts from their molds, etc. . . . In order to make such precision cuts, the blade of the knife must be extremely sharp, particularly when cutting paper or other sheet media. If the blade is dull it may tear the media instead of forming a precise incision.

Regardless of how sharp the blades on precision knives are made, in order to keep them affordable for the craft industry, the material used to form the blades does not hold such a sharp edge for prolonged periods of time. In order to address this issue, it is widely known in the industry to provide removable/replaceable blades for precision craft knives. Thus, once a blade is too dull to make accurate cuts, it can simply be replaced with a new blade.

However, there are number of drawbacks that exist with regard to replaceable blade precision craft knives. A first drawback is that when a knife blade needs to be replaced, typically the blade is removed by hand and the new blade placed inserted. This results in bare fingers frequently being placed in direct contact with the sharp end of the blade, sometimes causing injury. A second drawback is that replacement blade holders typically do not maintain a safe place for the old blades which again results in small sharp objects lying around on a work table. Yet another drawback with current replaceable blade craft knives is that the blade is usually protected when not in use by a separate cap. But, these caps are frequently lost and are inconvenient when performing frequent stop and start cutting, resulting in people simply not using the cap in most instances. As such, there is no replaceable blade retractable knife and cartridge assembly that combines effective safety features with ease of use.

### OBJECT AND SUMMARY OF THE INVENTION

It is an object of the present invention to overcome the drawbacks associated with the prior art to provide a precision knife and blade cartridge that includes an easy an effective means for installing new blades as well as disposing of old blades.

It is another object of the present invention to provide a precision knife and blade cartridge that has a retractable knife handle that is capable of interfacing properly with replacement blades stored in the blade cartridge and the further does not require a separate safety cap.

To this end the present invention provides for a combination precision knife and blade dispenser. This combination includes a handle portion, having a sliding blade assembly therein, moveable between a first retracted position and a second forward position. The blade assembly further maintains a threaded blade opening.

A dispenser is also provided, configured to support at least one blade in a new blade portion thereof. The dispenser has a used blade portion configured to support at least one blade therein, where a user opens the new blade portion, manipulates the sliding blade assembly to the second forward position, and screws a threaded base of the at least one blade into the threaded blade opening in order to insert the blade into the handle portion. In order to dispose of the blade, the user opens the used blade portion of the blade dispenser, inserts the blade into the dispenser and unscrews the threaded base of the blade from the threaded blade opening.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a side view of the handle portion of the precision knife of the present invention, with no blade, in accordance with one embodiment of the present invention;

FIG. 2 is close up cut away view of the blade slide assembly shown in the front end of handle portion of the precision knife of FIG. 1, in accordance with one embodiment of the present invention;

FIGS. 3A and 3B are close up views of the activation knob, upper slot and forward and rear locking notches respectively, in accordance with one embodiment of the present invention;

FIG. 4 is a front view of the closed blade cartridge assembly, in accordance with one embodiment of the present invention;

FIG. 5 is front view of the closed blade cartridge assembly from FIG. 4 including a view of the interior of the cartridge holding the replacement blade, in accordance with one embodiment of the present invention;

FIG. 6 is a perspective view of the open blade cartridge assembly From FIG. 4, with the exposed blade ends and the handle portion of the precision knife, in accordance with one embodiment of the present invention;

FIG. 7 is a top view of the handle portion of the precision knife of the present invention with a blade in the forward position, in accordance with one embodiment of the present invention.

FIG. 8 is a side view of the handle portion of the precision knife of the present invention with a blade in the retracted position, the internally held blade shown in dotted outline, in accordance with one embodiment of the present invention; and

FIG. 9 is a perspective view of the open blade cartridge assembly From FIG. 4, with the exposed blade ends and the handle portion of the precision knife to remove a blade to the discard side of the cartridge, in accordance with one embodiment of the present invention.

### DETAILED DESCRIPTION

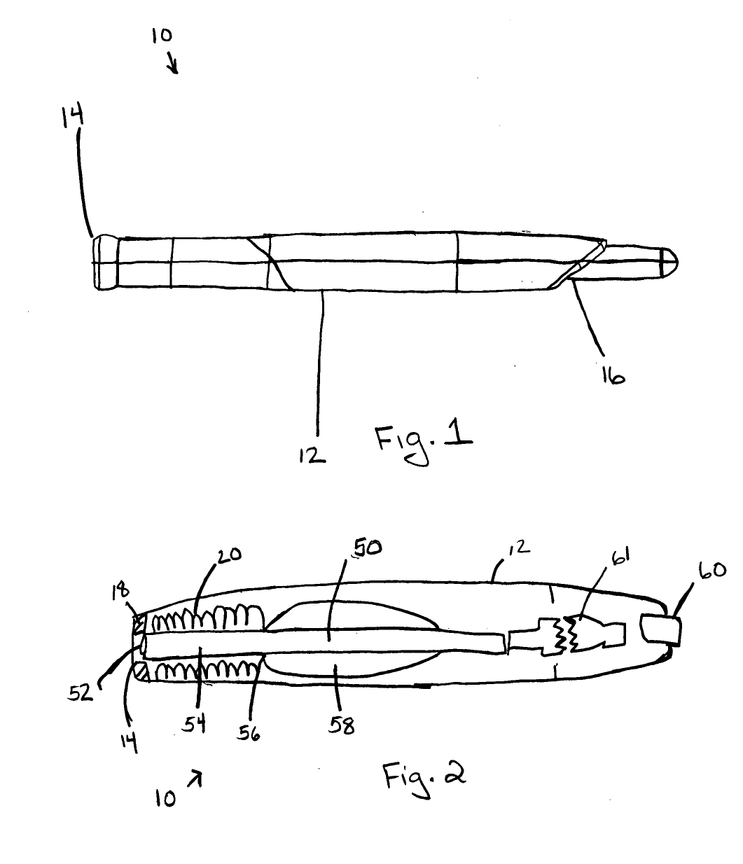

In one embodiment of the present invention, illustrated in FIG. 1, a precision knife 10 is shown having a handle portion 12, with a forward blade opening 14 and an upper opening 16 through which a sliding blade assembly 50 is manipulated to activate and/or retract knife 10 as explained in more detail below.

As shown in FIG. 2, a close up cut away side view is shown of handle portion 12 with slide assembly 50. Inside of forward blade opening 14 of handle portion 12, a circular blocking flange 18 is disposed to provide a stop for a spring 20. Spring 20 rests against blocking flange 18 on one side and against sliding blade assembly 50.

Sliding blade assembly 50 is configured to move within the inner cavity of handle portion 12 between a forward active position and a back closed position as explained in more detail below. Assembly 50 maintains a forward threaded blade opening 52, a forward blade cylinder 54, spring catch notch 56, expanded body portion 58 and activation knob 60.

As shown in FIG. 2, forward blade cylinder 54 is configured to slide forward through spring 20, allowing threaded blade opening to move towards and away from forward blade opening 14 of handle portion 12. Spring catch notch 56, formed by the sudden diameter increase between forward blade cylinder 54 and expanded body portion 58, is configured to provide a surface against which spring 20 can abut so as to bias sliding blade assembly 50 into a rearward in active portion.

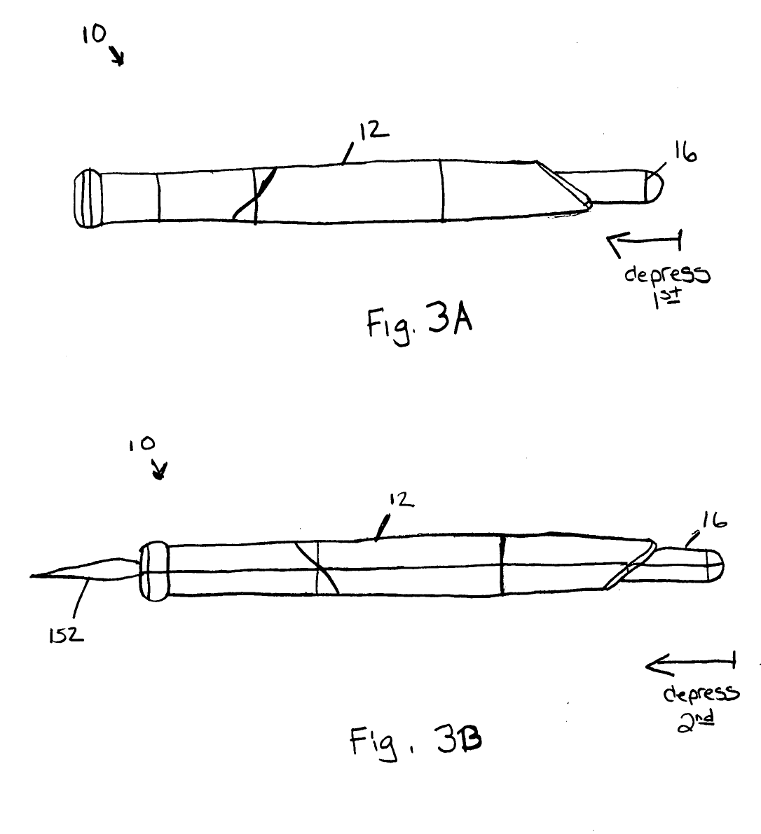

Activation knob 60 is positioned on at the rear of body portion 58. As shown in FIG. 3A, knob 60 is depressed a first time, starting from a closed position, to move assembly 50 forward against the bias of spring 20. As shown in FIG. 3B, once blade assembly 50 is forward into the active position, assembly 50 is held in the active forward position by a locking mechanism 61 near knob 60. Locking mechanism 61 may be any available locking system, such as those typically used in retractable point pens, including grooved rotating mechanisms and other such toggle designs. The reverse process is achieved by simply depressing knob 60 a second time.

It is understood that the above description of body portion 12 and blade assembly 50 are intended only as one example of the components of knife 10, but is in no way intended to limit the scope of the present invention. Any similar knife having similarly acting components is also within the contemplation of the present invention.

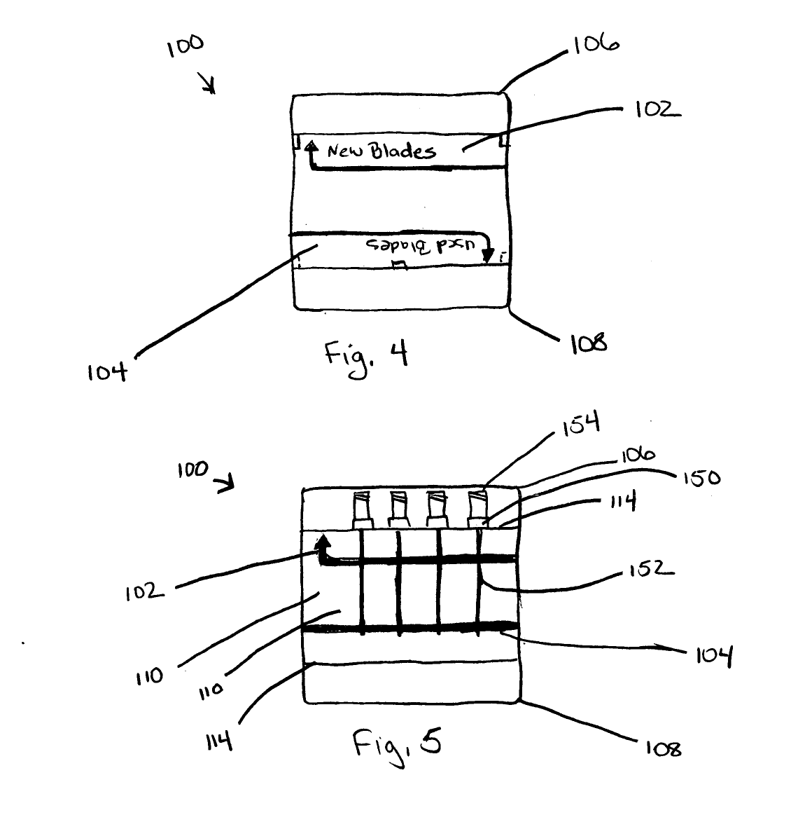

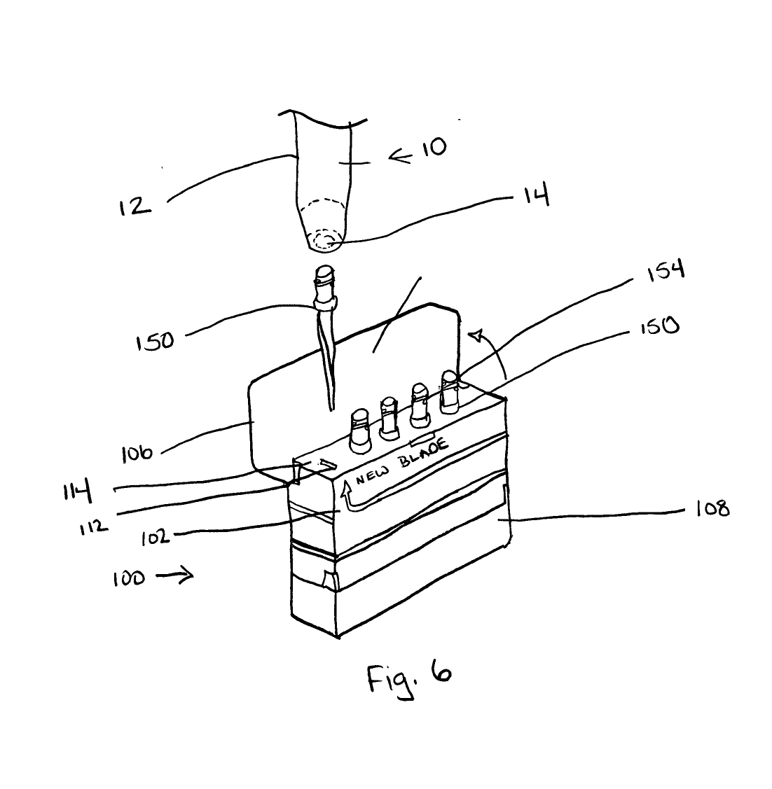

In one embodiment of the present invention, as illustrated in FIGS. 4 and 5, a blade dispenser 100 is provided. Blade dispenser 100 has a new blade portion 102 and a used blade portion 104. As shown in FIG. 5, a number of blades 150 are stored within the dispenser. Each blade 150 has an edge portion 152 and strew mount portion 154 configured to be supported in forward threaded blade opening 52 of blade assembly 50 as discussed in more detail below.

Within dispenser 100, a series of blade supports 110 are disposed within to support blades within dispenser 100 so that they are properly positioned for removal from new blade portion 102, or stored after insertion into used blade portion 104. Along the edge of dispenser 100, blade openings 112, corresponding to each blade support 110, are configured to allow edge portions 152 of blades 150 to enter into dispenser 100.

In the presently described example, dispenser 100 may have five new blades in new blade portion 102 with an equal number of slots for the used blades in used blade portion 104, however these amounts are by way of example only.

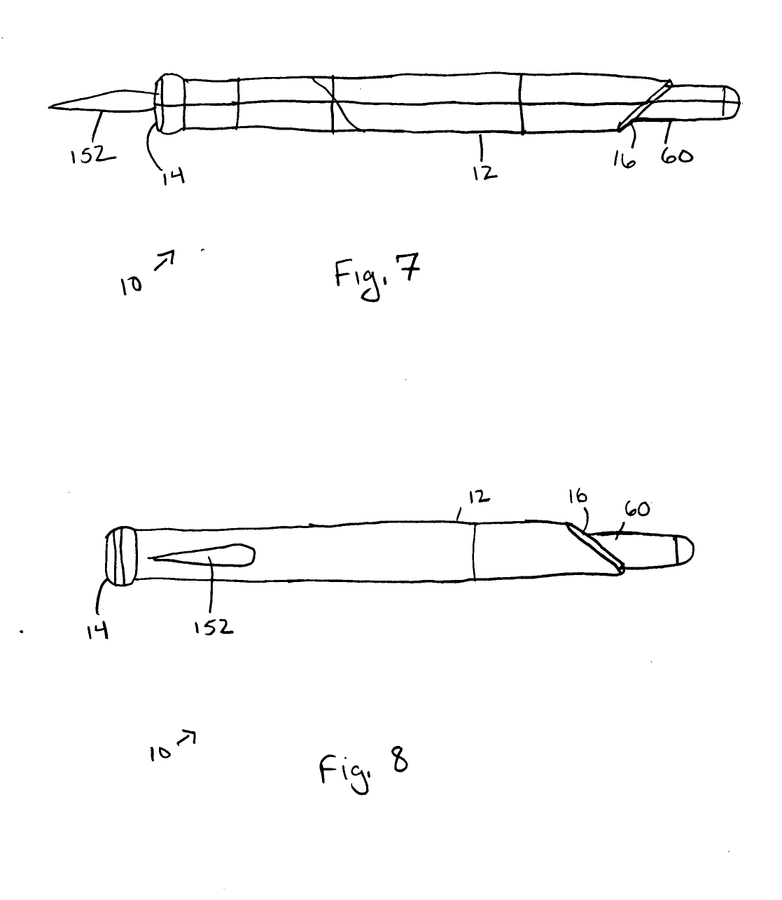

As shown in FIG. 6, new blade portion cover 106 is open, exposing only screw base portion 154 of blades 150 in new blade portion 102. The edge portion 152 is separated by a safety wall 114 from screw base 154. In order to a blade 150 to handle portion 12, sliding blade assembly 50 is moved to a forward position using knob 60 as discussed above. This places threaded blade opening 52 up near forward blade opening 14 of handle portion 12. Once in position, threaded blade opening 52 is pressed onto the back of threaded base 154 of blade 150 and rotated until fully screwed into place. By pulling handle portion 12 away from dispenser 100, edge portion 152 of blade 150 releases from its corresponding blade support 110 as shown in FIG. 7.

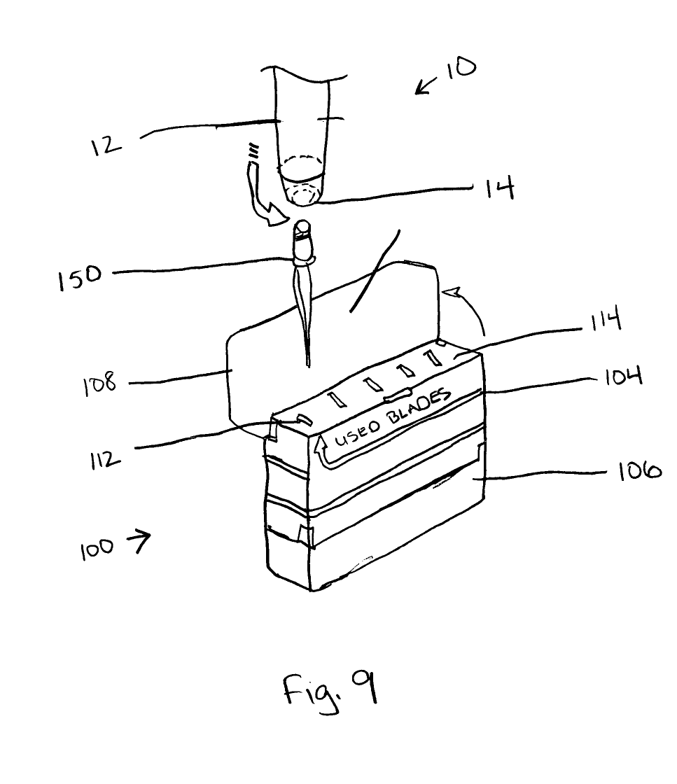

Knife 10 is now in a ready to use active position. After use, a user may desire to retract blade 150 into body portion 12, by simply re-pressing knob 60 of blade assembly 50 as discussed above. This results in edge portion 152 of blade 150 being completely contained within body portion 12 as shown in FIG. 8. This process of opening an closing blade 150 can be repeated when in use and in storage as desired by the user.

Once edge portion 152 of blade 150 is sufficiently dulled to require a new blade 150, used portion cover 108 of dispenser 100 is opened as shown in FIG. 9. Edge portion 152 of blade 150 is pressed forward to the active position and edge 152 is inserted through an opening 112 and into a corresponding blade support 110. Once coupled with blade support 110, handle portion 12 of knife 10 is rotated in a reverse direction until screw base portion 154 of blade 150 is completely released from threaded blade opening 52. A new blade 150 can then be retrieved as discussed above, until all of the new blades 150 are used at which point the dispenser can be discarded. Such an apparatus allows a user to employ the safety features of a both a retractable blade type knife while also providing the ability to change blades without ever having to contact the sharpened edge portions of the blades.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A combination precision knife and blade dispenser, said combination comprising:
a handle portion configured to receive a blade; and
a dispenser, said dispenser configured to support at least one blade in a new blade portion thereof, said dispenser further having a used blade portion configured to support at least one blade therein, wherein a user, manipulates said handle portion and engages a base of said at least one blade therein, and wherein in order to dispose of said blade, said user inserts said blade into said dispenser and disengages said base of said blade from said handle portion such that at no time does a user need to touch an edge portion of the blade.

2. The invention as claimed in claim 1, wherein said handle portion maintains a sliding blade assembly therein, moveable between a first retracted position and a second forward position.

3. The invention as claimed in claim 2, wherein said sliding blade assembly has a threaded blade opening for engaging said blade.

4. The invention as claimed in claim 3, wherein said base of said blade has a threaded base.

5. The invention as claimed in claim 1, wherein said new and used sections of said dispenser have openable covers.

6. The invention as claimed in claim 1, wherein said sliding blade assembly is moved to said second forward position using an activation knob that protrudes from the rear of said handle portion through an upper slot.

7. The invention as claimed in claim 6, wherein a spring is positioned between a blocking flange within said handle portion and a spring catch notch on said sliding blade assembly in order to bias said sliding blade assembly in a rearward direction.

8. The invention as claimed in claim 1, wherein said dispenser further comprises at least one blade support, configured to hold said at least one blade in position within said dispenser.

9. The invention as claimed in claim 1, wherein within said dispenser, said edge portion of said blade is protected by a safety wall such only said base portion of said blade is accessible by touch.

10. A combination precision knife and blade dispenser, said combination comprising:
a handle portion, said handle portion having a sliding blade assembly therein moveable between a first retracted position and a second forward position, said blade assembly having a blade opening; and
a dispenser, said dispenser configured to support at least one blade in a new blade portion thereof, said dispenser further having a used blade portion configured to support at least one blade therein, wherein a user manipulates said sliding blade assembly to said second forward position and engages a base of said at least one blade into said blade opening in order to insert said blade into said handle portion, and wherein in order to dispose of said blade, said user inserts said blade into said dispenser and disengages said base of said blade from said blade opening.

11. The invention as claimed in claim 10, wherein said sliding blade assembly has a threaded blade opening for engaging said blade.

12. The invention as claimed in claim 11, wherein said base of said blade has a threaded base.

13. The invention as claimed in claim 10, wherein said sliding blade assembly is moved to said second forward position using an activation knob that protrudes from the rear of said handle portion through an upper slot.

15. The invention as claimed in claim 10, wherein a spring is positioned between a blocking flange within said handle portion and a spring catch notch on said sliding blade assembly in order to bias said sliding blade assembly in a rearward direction.

16. A combination precision knife and blade dispenser, said combination comprising:
a handle portion, said handle portion having a sliding blade assembly therein moveable between a first retracted position and a second forward position, said blade assembly having a threaded blade opening; and
a dispenser, said dispenser configured to support at least one blade in a new blade portion thereof, said dispenser further having a used blade portion configured to support at least one blade therein, wherein a user opens said new blade portion, manipulates said sliding blade assembly to said second forward position, and screws a threaded base of said at least one blade into said threaded blade opening in order to insert said blade into said handle portion, and wherein in order to dispose of said blade, said user opens said used blade portion of said blade dispenser, inserts said blade into said dispenser and unscrews said threaded base of said blade from said threaded blade opening.

17. The invention as claimed in claim 16, wherein said blade has a first edge portion and a second screw base portion.

18. The invention as claimed in claim 17, wherein within said dispenser when opened, said edge portion is protected by a safety wall such only said screw base portions is accessible by touch.

19. The invention as claimed in claim 16, wherein said sliding blade assembly is biased in said first retracted position by a spring within said handle portion.

20. The invention as claimed in claim 19, wherein said sliding blade assembly is moved to said second forward position using an activation knob that protrudes from the rear of said handle portion through an upper slot.

21. The invention as claimed in claim 20, wherein said spring is positioned between a blocking flange within said handle portion and a spring catch notch on said sliding blade assembly.

22. A method for operating a combination precision knife and blade dispenser, said method comprising the step of:
activating a sliding blade assembly to a second forward position from a first retracted position within a handle portion of said knife, said assembly having a forward blade opening;
engaging a new blade portion of a dispenser containing at least one knife therein, said knife having an edge portion and a base portion, wherein only said base portion is exposed;
attaching said base portion of said blade into said forward blade opening;
removing said blade from said dispenser;
wherein when said edge portion of said blade is dull from use or otherwise:
inserting said edge portion of said blade into said used blade portion of said dispenser; and
disengaging said base portion of said blade from said forward blade opening, such during the entire method for operating a combination precision knife and blade dispenser, a user need not touch said edge portion of said blade.
